(19) United States
(12) Patent Application Publication
(10) Pub. No.: US 2007/0164079 A1
(43) Pub. Date: Jul. 19, 2007

(54) Electronic component mounting method, and circuit substrate and circuit substrate unit used in the method

(75) Inventors: Masato Mori, Osaka (JP); Hiroaki Onishi, Osaka (JP); Masato Hirano, Osaka (JP); Kazuto Nishida, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/597,949

(22) PCT Filed: Feb. 24, 2005
(86) PCT No.: PCT/JP05/03043

§ 371 Date: Nov. 6, 2006

(30) Foreign Application Priority Data
Feb. 24, 2004 (JP) 2004-048356
Feb. 27, 2004 (JP) 2004-054674

(51) Int. Cl. A47J 36/02

(52) U.S. Cl. 228/101

(57) ABSTRACT

An electronic component mounting method comprising: supplying an unhardened reinforcing resin on a circuit substrate; supplying a solder paste on bond areas of the circuit substrate on which electrodes of the electronic components are to be bonded; placing the electronic components on the circuit substrate; and heating and then cooling the circuit substrate with the reinforcing resin, the solder paste, and the electronic components carried thereon. The mounting method enables mounting of components with high joint reliability, while incorporating the conventional surface mount process steps. The method may also be applied to the mounting of smaller electronic components with narrower pitch without deteriorating productivity or mounting quality.

### TECHNICAL FIELD

The present invention relates to an electronic component mounting method, and more particularly to a method of reinforcing the joints between electronic components and circuit substrate using resin, and to a circuit substrate and a circuit substrate unit on which electronic components have been mounted, which are used in this method.

### BACKGROUND ART

Surface mount technologies are commonly known as methods of mounting electronic components on a circuit substrate by solder-bonding. The surface mount process usually includes the following steps:

1. Solder Paste Printing Step

Solder paste, which is the bonding material, is printed on electrode lands of the circuit substrate.

2. Electronic Component Placing Step

Electronic components are placed such that their electrodes are positioned on the solder paste printed on the electrode lands of the circuit substrate.

3. Reflow Step

The solder paste is heated and molten so that the electronic components are solder-bonded on the circuit substrate.

In the meantime, as the electronic equipment has become smaller, thinner, and more lightweight in recent years, the size of electronic components has been decreasing with greater speed, and electrodes of area array component packages such as CSP (chip size package) are now much more narrowly spaced. Accordingly, the amount of solder used for bonding the electronic components to the circuit substrate is now very small, posing the problem of lowered joint strength.

In view of this, as a bonding method that can reinforce the joints between electronic components and circuit substrate, one approach has been proposed, wherein a sheet of thermosetting flux resin is bonded on the circuit substrate, on which solder has been applied on the electrode lands, and by applying heat after placing the electronic components on the sheet, the components are solder-bonded and joints are reinforced (see, for example, Patent Document 1).

This conventional reinforcement technique is described with reference to FIG. 9A to FIG. 9F. Referring to FIG. 9A, a circuit substrate 21 includes electrode lands (not shown) on which solder 23 has been applied. A sheet of thermosetting flux resin 24 is bonded on this circuit substrate 21 (FIG. 9B and FIG. 9C), and an electronic component 25 is placed on the sheet (FIG. 9D and FIG. 9F). Then, heat is applied by setting the substrate in a reflow furnace, so that the electrodes 25a of the electronic component 25 are bonded to the circuit substrate 21 by the solder 23, and at the same time the thermosetting flux resin 24 hardens, whereby the solder joints are reinforced by hardened resin sheet 27 (FIG. 9F).

Another known joint reinforcement technique is a capillary flow method. This method includes supplying a reinforcement material to the solder joints after the surface mount process steps (solder paste application, component placement, and solder bonding (reflow)), and applying heat for a specified period of time to harden the reinforcement material and to achieve the reinforcing effect for the joints.

This mounting process is described with reference to FIG. 10A to FIG. 10F. Referring to FIG. 10A, a circuit substrate 21 is first supplied, which includes electrode lands 22, to which electrodes 25a of a chip component 25 or electrodes 26a of a CSP 26 will be bonded.

Next, in the step of printing solder paste, a metal mask (not shown) formed with a desired pattern of apertures is superposed on the circuit substrate 21 set in position, and a printing squeegee (not shown) that is in contact with the mask with appropriate pressure is moved straight along the printing direction to fill the solder paste in the apertures of the mask, after which the mask is removed from the circuit substrate 21; as a result, the solder paste 28 is applied by printing through the mask on the electrode lands 22 of the circuit substrate 21 (FIG. 10B).

Next, in the electronic component placement step, the electronic components 25 and 26 are picked up and positioned using an electronic component placement suction nozzle (not shown), and are placed on the circuit substrate 21 (FIG. 10C). At this time the electrodes 25a of the chip components 25 and electrodes 26a of CSPs 26 are placed on the solder paste 28 printed on the electrode lands 22, and the electronic components 25 and 26 are retained by the adhesive power of the solder paste 28 and fed to the next step.

Next, in the reflow step, heat is applied using hot air or a heat source such as an infrared heater (not shown) to melt the printed solder paste 28, so that the electronic components 25 and 26 are bonded on the circuit substrate 21 by the solder 29 that has molten and then set (FIG. 10D).

The solder bonding of the electrodes 25a and 26a of the electronic components 25 and 26 to the electrode lands 22 of the circuit substrate 21 is complete through the above process steps, but there is the problem of lowered joint reliability because of insufficient joint strength of solder 29, with the electrodes being now much smaller and more narrowly spaced, as package components such as CSPs have become smaller and include more pins in recent years. Therefore, another process step is added here, in which reinforcing resin, which is referred to as underfill, is filled between the circuit substrate 21 and the CSP 26 and hardened. In this underfill application step, unhardened resin material 31 is applied in between the circuit substrate 21 and the CSP 26 bonded with the solder 29, using an application device (not shown), whereby the resin fills the gap by the capillary action (FIG. 10E).

Lastly, in the underfill hardening step, heat is applied using hot air or a heat source such as an infrared heater (not shown) to harden the filled resin material 31, and the hardened reinforcing resin 32 bonds the CSP 26 to the circuit substrate 21 and reinforces the joints (FIG. 10F). Circuit substrate units including the circuit substrate 21 and the electronic components 25 and 25 mounted on the substrate were conventionally produced through the above process steps.

However, with the electronic component mounting method shown in FIG. 10A to FIG. 10F, additional steps of filling and hardening underfill are necessary after the completion of soldering the electrodes of the electronic components 25 and 25 to the electrode lands 22 on the circuit substrate 21, and therefore the production process is complex and the cost is high, and also the productivity is deteriorated.

With the downsizing and the increase in functionality of electronic equipment in recent years, there are more demands for smaller and higher-density electronic component substrates, and the trend for smaller package components such as CSPs with more pins, and consequentially for smaller and narrower-pitch electrodes, is still progressing. With the recent commencement of mass-production of CSPs with an electrode pitch (or ball pitch) of 0.4 mm, it is expected that the component electrode pitch will be made even narrower in future. In the meantime, for the mounting of electronic components including CSPs with an electrode pitch of 0.5 mm and chip components of conventional sizes such as 1.0×0.5 mm or 0.6×0.3 mm, solder cream is printed on the circuit substrate using a uniform thickness metal mask of a thickness of 0.1 mm or more (usually about 0.1 to 0.15 mm), the solder being printed to a uniform thickness for all the electronic components. However, the size of the apertures in the mask is too small for CSPs with an electrode pitch of 0.4 mm or less, and with the conventional mask thickness of 0.1 mm or more, the solder cream clogs up the apertures in the mask and causes a print failure such as a missing print. If the mask thickness is reduced to avoid this problem, the amount of solder cream for the conventional size electronic components becomes too small, because of which the solder joint strength after the mounting is decreased and the joint reliability deteriorated. Thus because of the decrease in the electrode pitch of CSPs, there arises a problem that conventional size electronic components and narrow-pitch components cannot collectively be mounted on the same circuit substrate.

As means for solving this problem, mounting methods called “no-flow underfill” have been proposed (see, for example, Patent Document 2). The no-flow underfill method uses a resin material that contains flux component; it provides the flux effect during the soldering, as well as the joint reliability enhancing effect as with the above-described underfill when it hardens.

The process steps of this no-flow underfill method are described with reference to FIG. 11A to FIG. 11E. Referring to FIG. 11A, a circuit substrate 21 is first supplied, which includes electrode lands 22, to which electrodes 25a of a chip component 25 or electrodes 26a of a CSP 26 will be bonded.

Next, in the step of printing solder paste, solder paste 28 is applied by printing, using a uniform thickness metal mask having a thickness of 0.1 mm or more and being formed with a desired pattern of apertures. The mask does not have apertures in the area that matches the electrode lands 22 on which a narrow-pitch CSP 26 will be mounted; as shown in FIG. 11B, the solder paste 28 is not printed on the electrode lands 22 on which the narrow-pitch CSP 26 will be mounted. This prevents a print failure caused by a missing print in the part where the narrow-pitch CSP 26 will be mounted, which may occur with the use of the conventional mask having a thickness of 0.1 mm or more.

Next, in the no flow underfill application step, as shown in FIG. 11C, a necessary amount of unhardened resin material 33 is applied on the electrode lands 22 for the narrow-pitch CSP 26, using an application device (not shown).

Next, in the electronic component placement step, the electronic components 25 and 26 are picked up and positioned one after another using an electronic component placement suction nozzle (not shown), and are placed on the circuit substrate 21 as shown in FIG. 11D. At this time, the electrodes 25a of the chip component 25 and the electrodes 26a of the CSP 26 are placed on the solder paste 28 and the unhardened resin material 33 printed and applied on the electrode lands 22, respectively, and the components 25 and 26 are retained by the adhesive power of the solder and resin and fed to the next step.

Lastly, in the reflow step, heat is applied using hot air or a heat source such as an infrared heater (not shown) to solder the electronic components 25 and 26 on the circuit substrate 21 as shown in FIG. 11E. As the solder paste 28 melts, the electrodes 25a of the chip component 25 are bonded to the electrode lands 22 by solder 29, and as the electrodes 26a of the narrow-pitch CSP 26 themselves, which are formed as solder balls, melt, they are bonded to the electrode lands. 22 by solder 30. In this reflow step, the unhardened resin material 33 also hardens, and hardened reinforcing resin 34 securely bonds the narrow-pitch CSP 26 on the circuit substrate 21, reinforcing the joints between the electrodes 26a of the CSP 26 and electrode lands 22.

[Patent Document 1 ] Japanese Patent Publication No. 2001-239395

[Patent Document 2 ] Japanese Patent No. 2589239

However, with the electronic component mounting method shown in FIG. 9A to FIG. 9F which uses a sheet of thermosetting flux resin 24 to reinforce the joints, the need of providing solder 23 beforehand on the electrode lands of the circuit substrate 21 badly affects the productivity. Another problem was that, when the substrate is set in the reflow furnace after the electronic components 25 have been placed on the flux resin sheet 24, the components 25 sometimes came off because of insufficient retention force.

With the capillary flow technique shown in FIG. 10A to FIG. 10F, the problem is as has been described above, and the no-flow underfill method shown in FIG. 11A to FIG. 11E, which is designed to solve the problem, has the following problems.

One problem results from the fact that no solder paste is printed on the electrode lands 22 on which the narrow-pitch CSP 26 will be mounted. The electrodes 26a (balls) of CSPs usually have a height variation; as shown in FIG. 11D, when a narrow-pitch CSP 26 is mounted, while higher electrodes 26amake contact with the electrode lands 22, lower electrodes X do not reach the lands 22. If they undergo the reflow process in such a state with the electrode height variation, some electrodes 26a may not be bonded to the electrode lands 22 as indicated by Y in FIG. 11E, thus a mounting defect may result from a bond failure.

Another problem with the no-flow underfill method is associated with the soldering of the electrodes 26a of the CSP 26 that are formed as solder balls and molten to be bonded on the electrode lands 22 of the circuit substrate 21; because the amount of solder that forms the electrodes 26 is very small, the joint strength after the soldering is very low, and good joint reliability cannot be secured even with the reinforcement using the reinforcing resin 34.

A further problem is that this method presupposes that the electrodes 26a of the CSP 26 are formed as solder balls that melt by the heat during the reflow process and precludes from being mounted the CSPs 26 with electrodes 26a of other materials that do not melt by the heat during the reflow process, such as copper balls, brass balls, or high-temperature solder balls.

In view of the above problems in the conventional techniques, an object of the present invention is to provide an electronic component mounting method, which, while incorporating the conventional surface mount process steps, enables reinforcement of solder joints of electronic components using reinforcing resin at the same time when the components are solder-bonded on a circuit substrate and thereby enables mounting of components with high joint reliability, and which can be applied to the mounting of smaller electronic components with narrower-pitch electrodes without deteriorating productivity or mounting quality; a circuit substrate used in the method; and a circuit substrate unit on which electronic components have been mounted.

### DISCLOSURE OF THE INVENTION

The present invention provides an electronic component mounting method, in which joints between a circuit substrate and electronic components are reinforced using resin, the method comprising: supplying an unhardened reinforcing resin on the circuit substrate; supplying a solder paste on specified bond areas of the circuit substrate on which electrodes of the electronic components are to be bonded; placing the electronic components on the circuit substrate; and heating and then cooling the circuit substrate with the reinforcing resin, the solder paste, and the electronic components carried thereon.

With this method, the conventional surface mounting process steps are basically adopted, with only simple process steps being added, to reinforce the solder joints of the electronic components with the reinforcing resin at the same Lime when the components are solder-bonded to the circuit substrate, and therefore the joint reliability between the components and substrate is improved without affecting the productivity, and the method is particularly effective in mounting small electronic components with narrower-pitch electrodes, which need to be bonded with a very small amount of solder.

The method comprising: supplying a sheet-form resin on the circuit substrate; supplying the solder paste on the sheet-form resin; placing the electronic components; heating to reflow the solder paste and then cooling; and solder-bonding the electronic components on the circuit substrate and hardening the sheet-form resin, the steps being preferably performed in this order.

With this method, because of the solder paste supplied on the areas where the electronic components are to be placed, the components are firmly retained on the circuit substrate by the viscous force of the solder paste and do not come off. When heat is applied to reflow the solder paste, the sheet-form resin softens, allowing the molten solder to pass through the sheet and to bond the electrodes of the components to the circuit substrate. After that, the sheet-form resin hardens and reinforces the joints as well as bonds the electronic components on the circuit substrate, and thus the joints between the components and substrate are reinforced and the joint reliability is improved. This electronic component mounting process adopts the conventional surface mounting process steps as they are, and achieve the effect of reinforcing the joints of the electronic components collectively at the same time when mounting the components, with only one additional step of bonding the sheet-form resin on the circuit substrate before supplying the solder paste.

The sheet-form resin may include equally spaced apertures so that solder that has molten by the heat during the reflow flows through the softened sheet-form resin through the apertures for easy bonding of the electrodes of the electronic components to the circuit substrate.

The sheet-form resin may include recesses at positions that match the electrode bond areas on the circuit substrate so that molten solder easily flows through the thin parts in the recesses of the sheet-form resin for reliable bonding of the electrodes of the electronic components to the circuit substrate. Also, because the solder paste is filled in the recesses, the amount of solder paste is increased without increasing the thickness of the mask used for supplying the solder paste, and therefore a necessary amount of solder paste is supplied even for a fine pitch pattern.

The sheet-form resin may include holes at positions that match the electrode bond areas on the circuit substrate so that solder that has molten by the heat during the reflow bonds the electrodes of the electronic components to the matching areas on the circuit substrate, whereby the bonding between the component electrodes and substrate is further facilitated.

As one alternative, the method comprising: printing the solder paste on the specified bond areas of the circuit substrate where the electrodes of the electronic components are to be bonded; restricting fluidity of the solder paste so that the solder paste retains its shape as printed; applying the thermosettable reinforcing resin on the circuit substrate including the solder paste; placing the electronic components on the circuit substrate; and solder-bonding the electronic components on the circuit substrate and hardening the reinforcing resin, the steps being preferably performed in this order.

With this method, as the fluidity of the printed solder paste is restricted and reinforcing resin is applied on the circuit substrate including this solder paste, the solder paste remains intact as printed during the application of the reinforcing resin, and after the electronic components have been mounted afterwards, heat is applied to bond the components and to harden the reinforcing resin, i.e., the mounting process is simple and carried out with good productivity. Also, should it become necessary to make the printing mask thickness thinner due to adoption of smaller electronic components with narrower-pitch electrodes which causes a reduction in the amount of bonding material, the components are still bonded to the substrate by the reinforcing resin, and the solder paste remains intact in shape and accommodates a variation in the electrode height as mentioned above, wherefore mounting is performed with good mounting quality and high joint reliability.

While restricting fluidity of the solder paste, it is preferable to control the fluidity such that the solder paste retains its shape as printed during the application of the reinforcing resin but deforms when a load is applied when the electronic components are mounted. Preferably, while restricting fluidity of the solder paste, the solder paste is dried using any of hot air, a heater, microwave, light or the like, or may be dried in a vacuum so as to dry the solder by volatilizing the solvent or the like in the material. The reinforcing resin should preferably be a resin material that has a flux effect.

The present invention also provides a circuit substrate, which includes a sheet-form resin arranged on a surface on which electronic components are to be bonded, the resin being softened by heat applied during heating for reflow of a solder paste to allow the molten solder above to flow down onto the circuit substrate. Preferably, the sheet-form resin includes equally spaced apertures, or recesses at the positions matching the areas where electrodes will be bonded, or holes at the positions matching the areas where electrodes will be bonded.

With the use of this circuit substrate, the conventional surface mounting process steps may be incorporated in the above-described electronic component mounting method, to achieve its effects

The present invention also provides a circuit substrate unit, including electronic components, a circuit substrate having electrode lands on which electrodes of the electronic components are to be bonded, solder joints between the electrodes of the electronic components and the electrode lands of the circuit substrate, and a reinforcing resin arranged on the circuit substrate such as to reinforce the solder joints, wherein the reinforcing resin is composed of a single resin material with a substantially uniform thickness arranged and hardened continuously over the entire area of the circuit substrate or at least over a specified area in which a plurality of the electronic components have been placed.

With this design, the circuit substrate units are produced by the above-described electronic component mounting method with high joint reliability between the components and substrate and with good productivity. Even when the components are densely mounted on the substrate and closely spaced from one another, their joints are reinforced reliably and with good productivity, due to the reinforcing resin that is arranged and hardened collectively over the entire area where the components are placed.

### BRIEF DESCRIPTION OF THE DRAWINGS

FIG. 1A to FIG. 1E illustrate process steps of an electronic component mounting method in accordance with a first embodiment of the present invention.

FIG. 2 is a perspective view of a circuit substrate unit produced by the electronic component mounting method of this embodiment.

FIG. 3 is a perspective view of a resin sheet in accordance with a third embodiment of the present invention.

FIG. 4A to FIG. 4F illustrate process steps of an electronic component mounting method in accordance with a fourth embodiment of the present invention.

FIG. 5 is a perspective view of a resin sheet in accordance with a fifth embodiment of the present invention.

FIG. 6A to FIG. 6E illustrate process steps of the electronic component mounting method of this embodiment.

FIG. 7A and FIG. 7B are cross-sectional views of a circuit substrate applicable to the first to fifth embodiments of the present invention.

FIG. 8A to FIG. 8F illustrate process steps of an electronic component mounting method in accordance with a sixth embodiment of the present invention.

FIG. 9A to FIG. 9F illustrate process steps of a conventional exemplary electronic component mounting method.

FIG. 10A to FIG. 10F illustrate process steps of an underfill mounting method which is another example of conventional technique.

FIG. 11A to FIG. 11E illustrate process steps of a no-flow underfill mounting method which is yet another example of conventional technique.

### BEST MODE FOR CARRYING OUT THE INVENTION

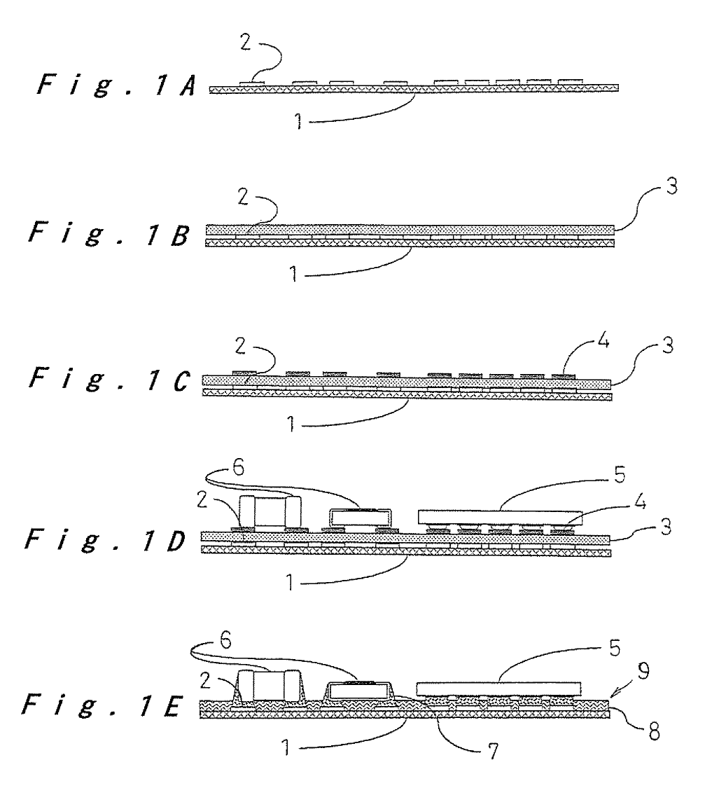

Preferred embodiments of the electronic component mounting method of the present invention will be hereinafter described with reference to FIG. 1A to FIG. 8F.

### FIRST EMBODIMENT

FIG. 1A to FIG. 1E illustrate process steps of an electronic component mounting method in accordance with a first embodiment of the present invention. This is one embodiment of a component mounting method, in which 1.0×0.5 mm chip components 6 (hereinafter simply referred to as “electronic components 6”) and a WL-CSP (Wafer-Level CSP) 5 with 0.4 mm pitch electrodes (hereinafter simply referred to as “electronic component 5”) are mounted on a circuit substrate 1. Referring to FIG. 1A, the circuit substrate 1 is made of, for example, glass/epoxy resin, and includes gold-plated electrode lands 2 for bonding purposes. A resin sheet 3, which is not hardened vet, is laid on the circuit substrate 1, as shown in FIG. 1B, in a succeeding step. The resin sheet 3 is a 30 μm thick thermosetting resin sheet, which is cut to the same size as the entire circuit substrate 1, and bonded on the circuit substrate 1. The resin sheet 3 may be cut to the size of a region where the electronic components 5 and 6 are bonded to the circuit substrate 1 to reinforce the joints, and its thickness is suitably selected depending on the size of the circuit substrate 1 and of the electronic components 5 and 6; usually it ranges from several tens to several hundreds μm.

The adhesive power of the resin sheet 3 on the surface bonded to the circuit substrate 1 was 2.0(N/mm³). Basically, the adhesive power may be set suitably so that the sheet does not come off of the circuit substrate 1 during the surface mounting process. The adhesive force of the resin sheet 3 on the surface on which solder will be printed and components will be mounted was 0.05(N/mm³). If a printing method is to be adopted for supplying solder paste, in particular, the adhesive power should preferably be adjusted to such a level that the resin sheet 3 will not stick to the substrate side of the metal mask that is used for the printing.

Solder paste 4 is supplied on the resin sheet 3 in the next step using a 80 μm thick metal mask upon the electrode lands 2 on the circuit substrate 1, as shown in FIG. 1C. After that, the chip components 6 and WL-CSP 5 are mounted as shown in FIG. 1D.

The circuit substrate 1 is heated in the next step with a heating method that uses a reflow furnace for the solder bonding and for the reinforcement of the joints as shown in FIG. 1E; whereby a circuit substrate unit 9, i.e., the circuit substrate 1 with electronic components 5 and 6 mounted thereon, is complete. The heat treatment in the reflow furnace is undertaken according to a temperature control process of about 400 seconds consisting of a temperature rising period of from room temperature to 130° C., a preheating period of from 140 to 180° C. in which solder paste flux is activated, a final heating period of from about 180 to 250° C. in which solder melts and electronic components 5 and 6 are solder-bonded to the circuit substrate 1, and a cooling period of from 240° C. to room temperature.

In the heating period that takes about several to 350 seconds during the reflow process, the resin sheet 3 softens and molten solder penetrates through the softened resin sheet 3, whereby the electronic components 5 and 6 are bonded to the circuit substrate 1 with the solder 7. After that, in the cooling period, the resin sheet 3 loses its fluidity and hardens, and this hardened reinforcing resin 8 covers the joints and bonds the electronic components 5 and 6 to the circuit substrate 1, thus reinforcing the joints between the electronic components 5 and 6 and the circuit substrate 1 and increasing the joint strength.

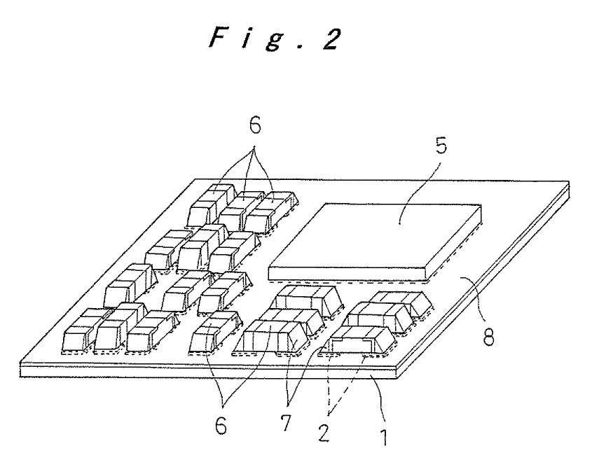

FIG. 2 illustrates a specific example of a circuit substrate unit 9 produced through the above electronic component mounting method. The circuit substrate unit 9 includes a plurality of electronic components 5 and 6 mounted on the circuit substrate 1, with the component electrodes being bonded to the electrode lands 2 on the substrate with solder 7, the solder joints being reinforced by the reinforcing resin 8 that is the hardened resin sheet 3 arranged on the circuit substrate 1, the reinforcing resin 8 being laid continuously over the entire surface of the substrate with a substantially uniform thickness. This way, even though the electronic components 5 and 6 are mounted on the circuit substrate 1 with a high mounting density and narrowly spaced from each other, the joints between these electronic components 5 and 6 and the circuit substrate 1 are reinforced with good productivity and in a reliable manner because of the reinforcing resin 8 arranged and hardened collectively over the entire region where the components 5 and 6 are mounted.

While chip components 6 and WL-CSP 5 are used as the electronic components in the example described above, any other electronic components may be used that are bonded by soldering such as connector components and the like.

### SECOND EMBODIMENT

Next, a second embodiment of the present invention will be described. In the following description of the embodiment, like elements to those of the previous embodiment are given the same reference numerals and will not be described again, and differences only will be described.

While thermosetting resin was used for the resin sheet 3 in the above-described first embodiment, thermoplastic resin is used in this embodiment for the resin sheet 3. With a thermoplastic resin sheet, the same effect of reinforcing the joints is achieved.

### THIRD EMBODIMENT

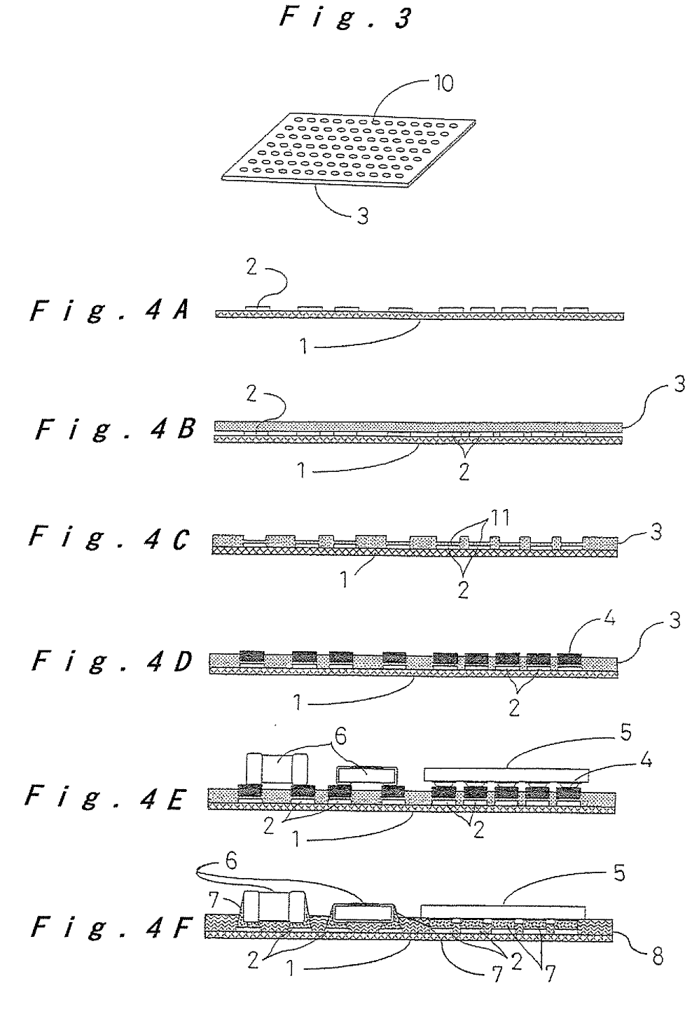

Next, a third embodiment of the present invention will be described with reference to FIG. 3. In this embodiment, the resin sheet 3 has a matrix of pores 10 with a diameter of, for example, 50 μm arranged at a constant interval of 50 μm. The diameter of the pores 10 may suitably be selected in the range of from several μm which corresponds to the particle size of solder paste 4 to as large as the size of the electrode lands 2.

In this embodiment, too, with the similar process steps of the first embodiment, the electronic components 5 and 6 are solder-bonded, and the joints are collectively reinforced. As the resin sheet 3 has equally spaced pores 10, it allows molten solder to flow through the pores 10 when the resin sheet 3 is softened in the heating period of about several to 350 seconds during the reflow process. Therefore the electrodes of the electronic components 5 and 6 are readily and reliably bonded to the electrode lands 2 on the circuit substrate 1 even if the thickness of the resin sheet 3, or the reinforcing resin 8, is increased, in order to seal the gaps between the electronic components 5 and 6 and the circuit substrate 1.

### FOURTH EMBODIMENT

Next, a fourth embodiment of the present invention will be described with reference to FIG. 4A to FIG. 4F. The difference between this embodiment and first embodiment is that a process step is added in which recesses 11 are formed in the resin sheet 3 on the circuit substrate 1 to match with the electrode lands 2 on the circuit substrate I as shown in FIG. 4C.

The mounting process is described in the order of steps; FIG. 4A and FIG. 4B illustrate the same steps as FIG. 1A and FIG. 1B; in the step of FIG. 4C, recesses 11 are formed in the resin sheet 3 on the circuit substrate 1 to match with the electrode lands 2 on the circuit substrate 1. The recesses 11 are formed by pressing a tool (not shown) onto the upper face of the resin sheet 3, the tool having projections on the lower face at positions that match the apertures in the metal mask for printing solder paste 4. Next, in the step of printing solder paste 4 shown in FIG. 4D, the solder paste 4 is supplied on the resin sheet 3 using the metal mask. In this step of printing solder paste 4, the solder paste 4 is filled not only in the apertures of the metal mask but also in the recesses 11 through the apertures. The steps of FIG. 4A and FIG. 4F that follow are the same as those of FIG. 1D and FIG. 1E.

In this embodiment, recesses 11 are formed to match with the electrode lands 2 on the circuit substrate 1, and molten resin readily passes through the thin parts in the recesses 11 of the resin sheet 3 so that the electrodes of the electronic components 5 and 6 are reliably bonded to the electrode lands 2. Also, because the solder paste 4 is filled in the recesses 11, the amount of solder paste is increased without increasing the thickness of the metal mask used for supplying the solder paste 4, and therefore a necessary amount of solder paste is supplied even for a fine pitch pattern.

### FIFTH EMBODIMENT

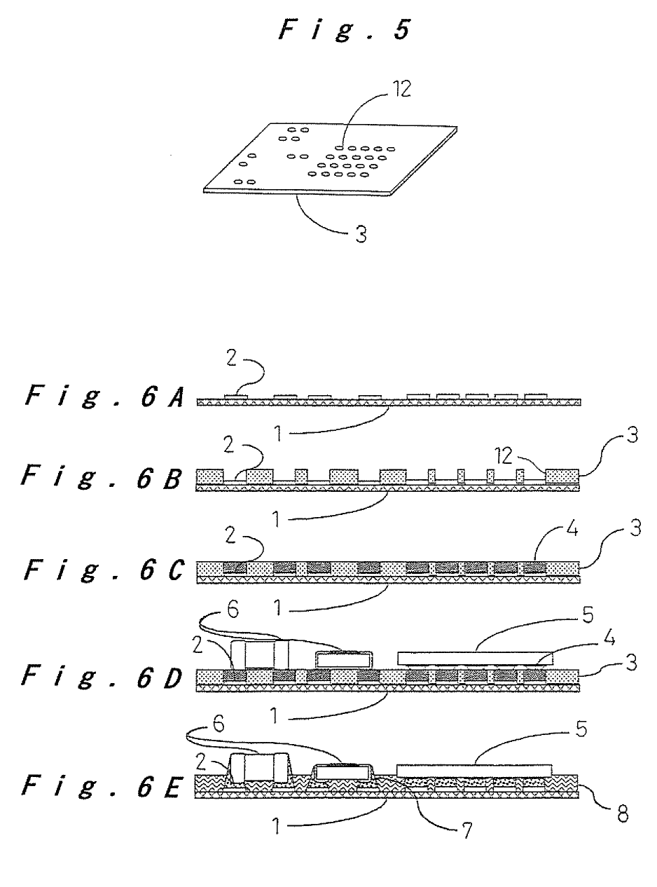

Next, a fifth embodiment of the present invention will be described with reference to FIG. 5 and FIG. 6A to FIG. 6E. In this embodiment, as shown in FIG. 5, the resin sheet 3 includes holes 12 formed to match with the electrode lands 2 on the circuit substrate 1.

In this embodiment, too, with the similar process steps of the first embodiment, the electronic components 5 and 6 are solder-bonded, and the joints are collectively reinforced. As the resin sheet 3 includes holes 12 formed to match with the electrode lands 2, solder joints are formed through the holes 12 by the solder that has molten by the heat during the reflow process, and therefore the electrodes of the electronic components 5 and 6 are readily and reliably bonded to the electrode lands 2 on the circuit substrate 1.

A more detailed description will be made with reference to FIG. 6A to FIG. 6E. As shown in FIG. 6A, the circuit substrate 1 is made of, for example, glass/epoxy resin, and includes gold-plated electrode lands 2. A resin sheet 3 is laid on the circuit substrate 1, as shown in FIG. 6B, in a succeeding step. The resin sheet 3 is a 120 μm thick thermosetting resin sheet, which is cut to the same size as the entire circuit substrate 1, and bonded on the circuit substrate 1. The resin sheet 3 is bonded such that the holes 12 match with the electrode lands 2 on the circuit substrate 1.

The adhesive force of the resin sheet 3 on the surface bonded to the circuit substrate 1 was 2.0(N/mm³). Basically, the adhesive force may be set suitably so that the sheet does not come off of the circuit substrate during the surface mounting process. The adhesive force of the resin sheet 3 on the surface on which solder will be printed and components will be mounted was 0.05(N/mm³). If a printing method is to be adopted for supplying solder paste, in particular, the adhesive force should preferably be adjusted to such a level that the resin sheet 3 will not stick to the substrate side of the metal mask that is used for the printing.

Solder paste 4 is supplied on the resin sheet 3 in the next step using a 80 μm thick metal mask upon the electrode lands 2 on the circuit substrate 1, as shown in FIG. 6C. After that, the chip components 6 and WL-CSP 5 are placed as shown in FIG. 6D.

The circuit substrate 1 is heated in the next step with a heating method that uses a reflow furnace for the solder bonding and for the reinforcement of the joints as shown in FIG. 6E. The heat treatment in the reflow furnace is undertaken according to a temperature control process of about 400 seconds consisting of a temperature rising period of from room temperature to 130° C., a preheating period of from 140 to 180° C. in which solder paste flux is activated, a final heating period of from about 180 to 250° C. in which solder melts and electronic components 5 and 6 are solder-bonded to the circuit substrate 1, and a cooling period of from 240° C. to room temperature.

In the heating period that takes about several to 350 seconds during the reflow process, the resin sheet 3 softens. The solder paste 4 melts, whereby the electronic components 5 and 6 are bonded to the circuit substrate 1 with the solder 7 through the holes 12. After that, in the cooling period, the resin sheet 3 loses its fluidity and hardens, and this hardened reinforcing resin 8 covers the joints and bonds the electronic components 5 and 6 to the circuit substrate 1, thus reinforcing the joints between the electronic components 5 and 6 and the circuit substrate 1 and increasing the joint strength.

### SISTH EMBODIMENT

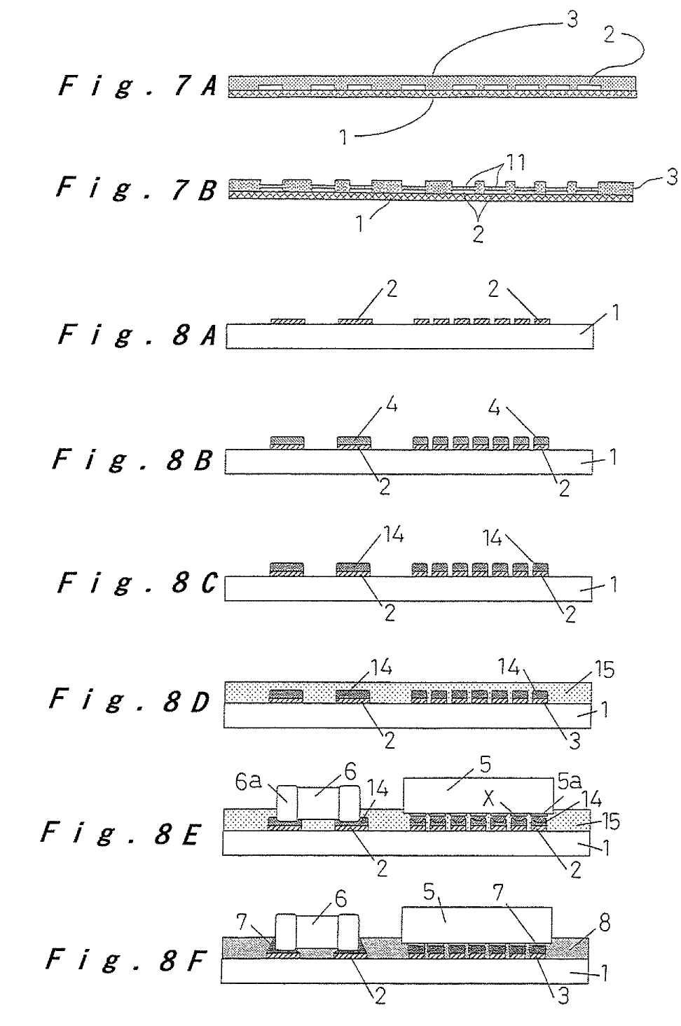

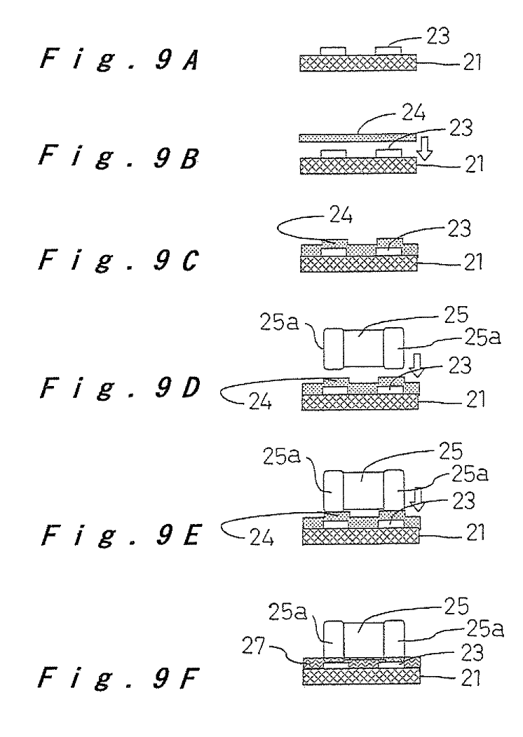

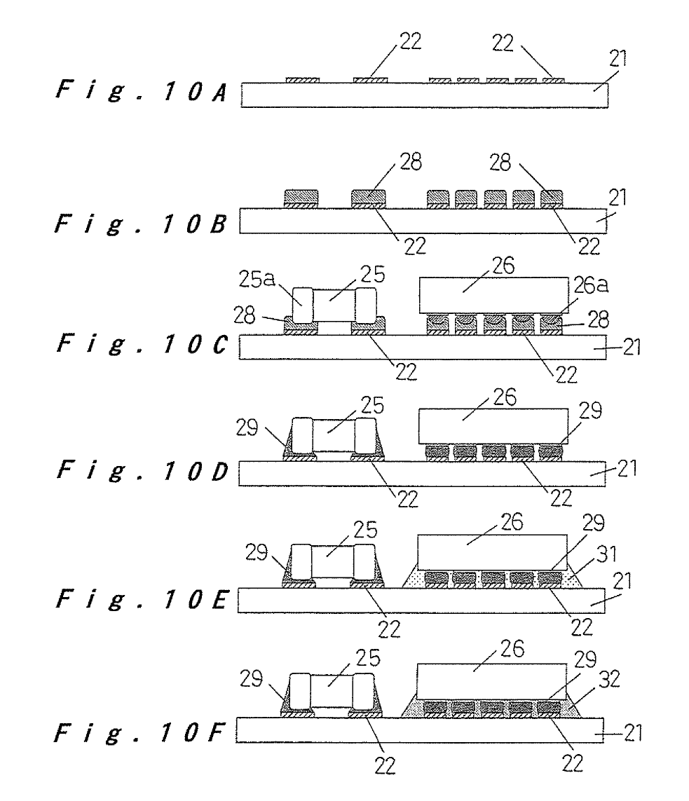

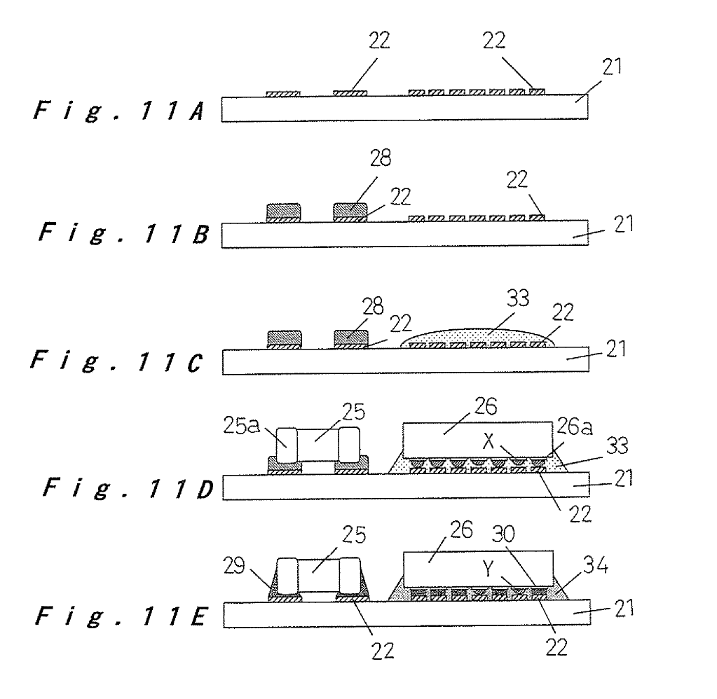

Next, a sixth embodiment of the present invention will be described with reference to FIG. 7A and FIG. 7B. In this embodiment, the resin sheet 3 is already bonded to the circuit substrate 1. By thus preparing the circuit substrate 1 that includes the resin sheet 3, it is only necessary to perform the conventional surface mounting process steps to achieve the effect of reinforcing the solder joints offered by the electronic component bonding method in accordance with the above-described first to fifth embodiments. The circuit substrate 1 of FIG. 7B shows the example of the fourth embodiment in which the resin sheet 3 includes recesses 11.

### SEVENTH EMBODIMENT

Next, a seventh embodiment of the present invention will be described with reference to FIG. 8A to FIG. 8F, which illustrate process steps of the electronic component mounting method.

Referring to FIG. 8A, numeral 1 represents a circuit substrate, and 2 represents electrode lands to which the electrodes of the electronic components 5 and 6 will be bonded; this circuit substrate 1 is fed to the next step of printing solder paste 4. In the step of printing solder paste 4, a metal mask (not shown) formed with a desired pattern of apertures is superposed on the circuit substrate 1 set in position, and a printing squeegee (not shown) that is in contact with the mask with appropriate pressure is moved straight along the printing direction to fill the solder paste 4 in the apertures of the mask, after which the mask is removed from the circuit substrate 1; as a result, the solder paste 4 is applied through the mask on the electrode lands 2 of the circuit substrate 1 as shown in FIG. 8B.

The thickness of the mask was 0.06 to 0.08 μm, which is thinner than the conventional 0.1 mm or more (usually 0.1 to 0.15 mm). By thus using a uniform thickness mask with which solder can be printed on the electrode lands 2 for CSPs 5, the solder paste 4 is printed in a stable manner for all the electrode lands 2 on which electronic components 5 and 6 are mounted including chip components 6 of the conventional size.

While the mask thickness was 0.06 to 0.08 mm in this embodiment, it is not limited to this range and the thickness may be suitably selected so that solder is printed on electrode lands on which narrow-pitch electronic components will be mounted.

Next, the process goes to a solder paste drying step, in which the circuit substrate 1, with solder paste (solder cream) 4 printed on the electrode lands 2, is heated on a hot plate (not shown), so as to dry the solder by volatilizing the solvent or the like in the solder paste 4, whereby a status shown in FIG. 8C is achieved, wherein the solder paste 14 has limited fluidity. Drying is performed for 20 to 120 seconds under the temperature from 120 to 180° C. The fluidity of the solder paste 14 is controlled such that, in an unhardened resin material application step and an electronic component placement step later, the solder paste 4 retains its shape as printed while the unhardened resin material flows when applied, but deforms when a load is applied when the electronic components 5 and 6 are placed.

While the circuit substrate 1 is entirely heated in this embodiment to dry the solder paste 4 covering the substantially entire area on the circuit substrate 1, this is not a requirement and part of solder paste 4 may be selectively dried so that a particular area covering one or more of specific electronic components is dried and not all the components on the circuit substrate.

While a hot plate is used in this embodiment as drying means, this is not a requirement and the solder paste 4 may be dried using any of hot air, a heater, microwave, light or the like, or may be dried in a vacuum.

Next, in the unhardened resin material application step, as shown in FIG. 8D, a necessary amount of thermosettable, unhardened resin material 15 is applied on the entire surface of the circuit substrate 1 including the solder paste 14 with limited fluidity, using an application device (not shown). A commonly used epoxy resin is preferably used as the unhardened resin material 15. The solder paste 14 with limited fluidity does not give in to the flow of the unhardened resin material 15 when it is applied and retains its shape as printed.

While the thermosettable, unhardened resin material 15 is applied on the substantially entire area of the circuit substrate 1 in this embodiment, this is not a requirement and as with the drying step, the resin may be applied to a selected area on the circuit substrate 1 that covers one or more of specific electronic components, and in that case the resin should preferably be applied to the area that has selectively been dried in the previous step.

While the resin is applied using an application device in this embodiment, this is not a requirement and a printing device or an ink jet device may be used, as long as a necessary amount of thermosettable, unhardened resin material 15 is uniformly supplied on the circuit substrate 1.

Next, in the electronic component placement step, the chip components 6 and CSP 5 are picked up and positioned one after another using an electronic component placement suction nozzle (not shown), and are placed on the circuit substrate 1 as shown in FIG. 8E. At this time, because the solder paste 14 with limited fluidity has a fluidity that is controlled such that the paste deforms when a load is applied when the chip components 6 and CSP 5 are placed as described above, the electrodes 6a and 5a of the mounted chip components 6 and CSP 5 stick into the solder paste 14 with limited fluidity, and since the electrodes are connected to the electrode lands 2 stably through the solder paste 14 with limited fluidity, even when there is a variation in the height of the CSP electrodes 5a and there is included a low electrode X, the height variation is accommodated and mounting defects caused by joint failures or the like are prevented.

Further, the mounted chip components 6 and CSP 5 are retained by deformation of the solder paste 14 with limited fluidity that deforms by the mounting load when the chip component 6 and CSP 5 are placed and by adhesive power of the thermosettable, unhardened resin material 15. Therefore, even though the amount of solder paste 14 used for the chip components 6 is decreased because of the use of a thinner mask that enables printing of solder on all the electrode lands 2, the retention force is not reduced and the chip components 6 and CSP 5 are securely held and brought to the next step, and thus mounting defects caused by missing components are prevented.

While no particular control scheme for the mounting load is adopted in this embodiment, the mounting load may be controlled so that components are placed with a desired load, thereby controlling the deformation amount of the solder paste 14 with limited fluidity so as to adjust retention force for the chip components 6 and CSP 5 and to adjust the spread of solder after the components are placed, whereby mounting defects caused by missing components and short circuits are reliably prevented.

In the last reflow process, heat is applied using hot air or a heat source such as an infrared heater (not shown) to melt the solder paste 14, so that, as shown in FIG. 8F, the components 6 and CSP 5 are soldered on the circuit substrate 1 by the solder that has molten and then set and solder joints 7 are formed. The reflow is performed using a standard temperature profile for lead-free solder, with 90 to 120 seconds of preheating at a temperature of from 140 to 180° C., a peak temperature of from 240 to 250° C., and a period of at least 30 seconds at 220° C. which is the solder melting temperature.

At this stage, the electrodes 6a of the chip components 6 are soldered to the electrode lands 2 by molten solder paste 14, and the electrodes 5a of CSP 5 are soldered to the electrode lands 2 by molten solder paste 14 and electrodes 5a themselves that have been formed as solder balls. At the same time, the unhardened resin material 15 hardens, and the chip components 6 and CSP 5 are bonded on the circuit substrate 1 by heated and hardened reinforcing resin 8 and the solder 5 joints 7 are reinforced. This way, as the CSP 5 is soldered using both the solder of the electrodes 5a and the solder paste 14, the joint strength after the soldering is improved, and also a high joint reliability is achieved because the solder joints 7 are reinforced by the heated and hardened reinforcing resin 8.

Further, because the chip components 6 are bonded on the circuit substrate 1 and the solder joints 7 are reinforced by heated and hardened reinforcing resin 8, even though the amount of solder cream for the chip components 6 is reduced by the use of a thinner mask that enables printing of solder on the electrode lands 2 for CSPs 5, a high joint reliability is achieved.

While the electronic components 5 and 6 are bonded on the circuit substrate 1 by the heated and hardened reinforcing resin 8 substantially all over the circuit substrate 1 in this embodiment, this is not a requirements, and the components 5 and 6 may be bonded with the heated and hardened reinforcing resin on the circuit substrate 1 in a selected area that matches the area where resin has been applied in the previous step.

While CSPs 5 are described as having solder ball electrodes 5a as one example in the above embodiments since CSPs are soldered with solder paste 14 that melts by the heat applied during the reflow process, this is not a requirement and other electronic components may be used that have electrodes 5a formed as copper balls, brass balls, or high-temperature solder balls that do not melt by the heat during the reflow process.

While one example has been shown in which the flux of the solder paste 14 is used for removing oxides or the like on the electrodes or electrode lands for the soldering, this is not a requirement, and to achieve an enhanced flux effect, the thermosettable reinforcing resin may be a resin that has a flux effect.

### INDUSTRIAL APPLICABILITY

The present invention enables reinforcement of solder joints of electronic components using a resin sheet at the same time when the components are solder-bonded on a circuit substrate, thereby improving reliability of the joints between the components and substrate without affecting productivity, and therefore the invention is useful for the mounting of electronic components with small and narrow-pitch electrodes that are bonded with a small amount of solder.

1. An electronic component mounting method in which joints between a circuit substrate and electronic components are reinforced using a resin, the method comprising: supplying an unhardened reinforcing resin on the circuit substrate; supplying a solder paste on bond areas of the circuit substrate of the electronic components are to be bonded; placing the electronic components on the circuit substrate; and heating and then cooling the circuit substrate with the reinforcing resin, the solder paste, and the electronic components carried thereon.

2. The electronic component mounting method according to claim 1, comprising: supplying a sheet-form resin on the circuit substrate; supplying the solder paste on the sheet-form resin; placing the electronic components and then cooling; and solder-bonding the electronic components on the circuit substrate and hardening the sheet-form resin, the steps being performed in this order.

3. The electronic component mounting method according to claim 2, wherein the sheet-form resin includes equally spaced apertures.

4. The electronic component mounting method according to claim 2, wherein the sheet-form resin includes recesses at positions that match the electrode bond areas on the circuit substrate.

5. The electronic component mounting method according to claim 2, wherein the sheet-form resin includes holes at positions that match the electrode bond areas on the circuit substrate.

6. The electronic component mounting method according to claim 1, comprising: printing the solder paste on the specified bond areas of the circuit substrate of the electronic components are to be bonded; restricting fluidity of the solder paste so that the solder paste retains its shape as printed; applying the thermosettable reinforcing resin on the circuit substrate including the solder paste; placing the electronic components on the circuit substrate; and solder-bonding the electronic components on the circuit substrate and hardening the reinforcing resin, the steps being performed in this order.

7. The electronic component mounting method according to claim 6, while restricting fluidity of the solder paste, the fluidity is controlled such that the solder paste retains its shape as printed during the application of the reinforcing resin but deforms when a load is applied when the electronic components are mounted.

8. The electronic component mounting method according to claim 7, while restricting the fluidity of the solder paste, the solder paste is dried so as to volatilize the solvent or the like in the solder paste.

9. The electronic component mounting method according to claim 8, wherein the solder paste covering a substantially entire area on the circuit substrate or covering a specified area is selectively dried.

10. The electronic component mounting method according to claim 8, wherein drying is carried out using any of hot air, a heater, microwave, and light or using vacuum drying method.

11. The electronic component mounting method according to claim 6, wherein the reinforcing resin is applied on a substantially entire area of the circuit substrate or on a specified area selectively.

12. The electronic component mounting method according to claim 6, wherein the reinforcing resin is a resin material having a flux effect.

13. The electronic component mounting method according to claim 6, wherein the reinforcing resin is used that has an effect of bonding the electronic components to the circuit substrate.

14. The electronic component mounting method according to claim 6, wherein the mounted electronic components are retained by deformation of the solder paste that deforms by a mounting load and by adhesive power of the reinforcing resin.

15. A circuit substrate comprising a sheet-form resin arranged on a surface on which electronic components are to be bonded, the resin being softened by heat applied during heating for reflow of a solder paste to allow the molten solder above to flow down onto the circuit substrate.

16. The circuit substrate according to claim 15, wherein the sheet-form resin includes equally spaced apertures.

17. The circuit substrate according to claim 15, wherein the sheet-form resin includes recesses at positions that match the electrode bond areas.

18. The circuit substrate according to claim 15, wherein the sheet-form resin includes holes at positions that match the electrode bond areas.

19. A circuit substrate unit, comprising: electronic components; a circuit substrate having electrode lands on which electrodes of the electronic components are to be bonded; solder joints between the electrodes of the electronic components and the electrode lands of the circuit substrate, and a reinforcing resin arranged on the circuit substrate such as to reinforce the solder joints, wherein the reinforcing resin is composed of a single resin material with a substantially uniform thickness arranged and hardened continuously over the entire area of the circuit substrate or at least over a specified area in which a plurality of the electronic components have been placed.
